(19) United States
(12) Patent Application Publication
(10) Pub. No.: US 2026/0363200 A1
(43) Pub. Date: Nov. 19, 2026

(54) Kennel Customization Device

(71) Applicants: Lauri Veimer, Clarksburg, MD (US); Joonas Lauri Veimer, Clarksburg, MD (US)

(72) Inventors: Lauri Veimer, Clarksburg, MD (US); Joonas Lauri Veimer, Clarksburg, MD (US)

(21) Appl. No.: 19/208,812

(22) Filed: May 15, 2025

(51) Int. Cl. A01K 1/03

(52) U.S. Cl. CPC A01K 1/033

(57) ABSTRACT

A kennel customization device for decorating and personalizing a pet's space includes a pet crate having a base and a plurality of walls. Each wall includes a plurality of first wires and a plurality of second wires intersecting the plurality of first wires. Decorations are couplable to the pet crate via clips. Each clip includes hub with a back side, a front side, a left side, a right side, a top side, and a bottom side. A primary channel extends inwardly through the left side and outwardly through the right side. A secondary channel extends inwardly through the top side and outwardly through the bottom side of the hub.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to kennel and more particularly pertains to a new kennel for decorating and personalizing a pet's space.

### (2) Description of Related Art Including Information Disclosed Under 37 CFR 1.97 and 1.98.

The prior art relates to kennels. There are many different types of kennels. Wire kennels are particularly popular because they can be made in many different sizes (thus accommodating many different sizes of pets), they allow the pets to see through the walls of the kennel, they are relatively lightweight, and they are durable. However, these wire creates are not very aesthetically pleasing. Thus, there is a need for decorations that can be added to these wire crates, allowing users to provide a personalized touch to their pet's rooms while also providing the versatility, durability, and other benefits of a wire kennel.

### BRIEF SUMMARY OF THE INVENTION

An embodiment of the disclosure meets the needs presented above by generally comprising a pet crate having a base and a plurality of walls. Each wall of the plurality of walls includes a plurality of first wires and a plurality of second wires that intersect the plurality of first wires. A plurality of decorations are couplable to the pet crate. A plurality of clips are coupled to the plurality of decorations for coupling the plurality of decorations to the pet crate. Each clip of the plurality of clips includes hub with a back side, a front side, a left side, a right side, a top side, and a bottom side. A primary channel extends inwardly through the left side and outwardly through the right side. The primary channel includes a pair of outer sections and a middle section that is concave complementary to a convex outer surface of a selectable first wire of the plurality of first wires. A secondary channel extends inwardly through the top side and outwardly through the bottom side of the hub. The secondary channel includes a pair of outer segments and a medial segment that is concave complementary to a convex exterior surface of an associated second wire of the plurality of second wires.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a kennel customization device according to an embodiment of the disclosure.

FIG. 2 is an isometric in-use view of an embodiment of the disclosure.

FIG. 3 is a top view of an embodiment of the disclosure.

FIG. 4 is a side view of an embodiment of the disclosure.

FIG. 5 is an isometric view of an embodiment of the disclosure.

FIG. 6 is an isometric view of an embodiment of the disclosure.

FIG. 7 is an isometric detail view of an embodiment of the disclosure.

FIG. 8 is a back view of an embodiment of the disclosure.

FIG. 9 is a back view of an embodiment of the disclosure.

FIG. 10 is an isometric detail view of an embodiment of the disclosure.

FIG. 11 is an in-use view of an embodiment of the disclosure.

FIG. 12 is a detail in-use view of an embodiment of the disclosure.

### DETAILED DESCRIPTION OF THE INVENTION

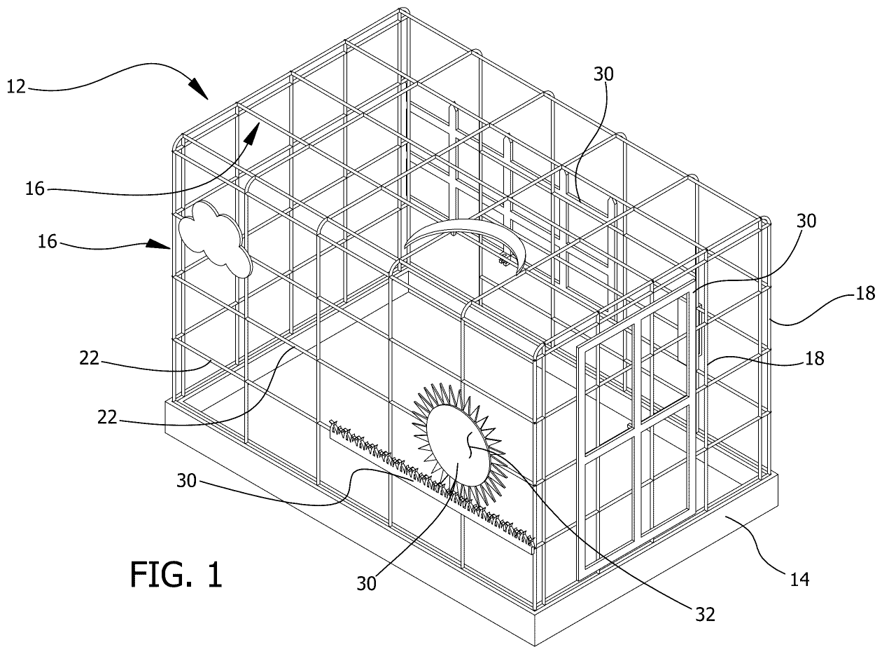

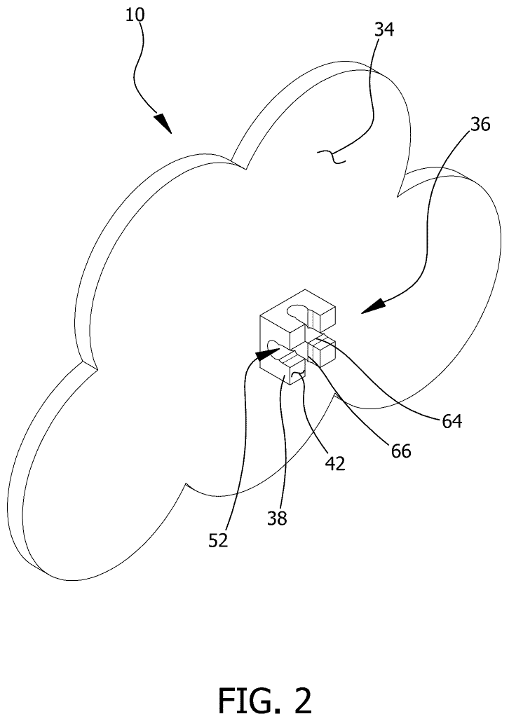

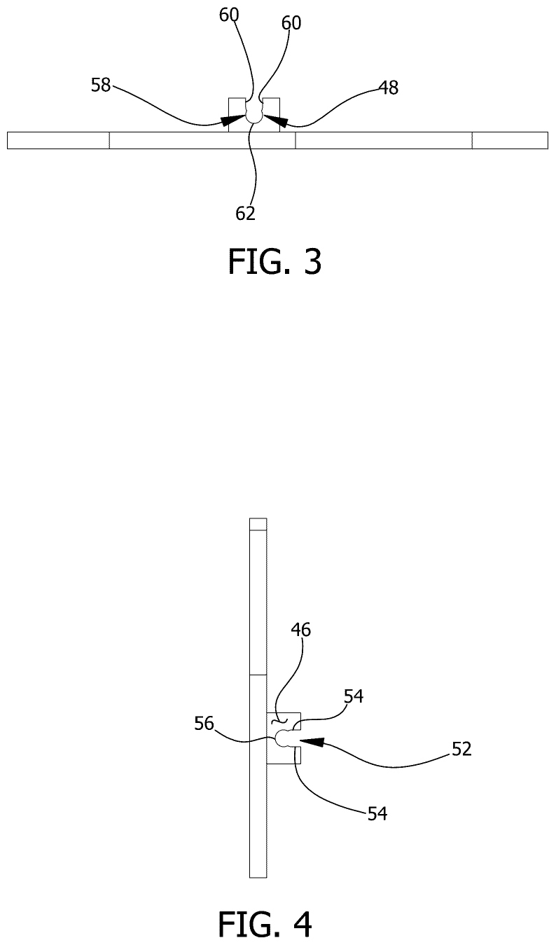

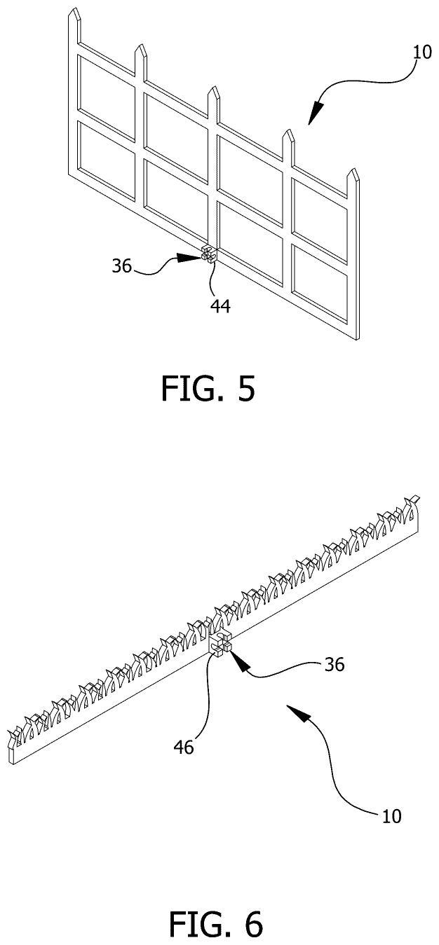

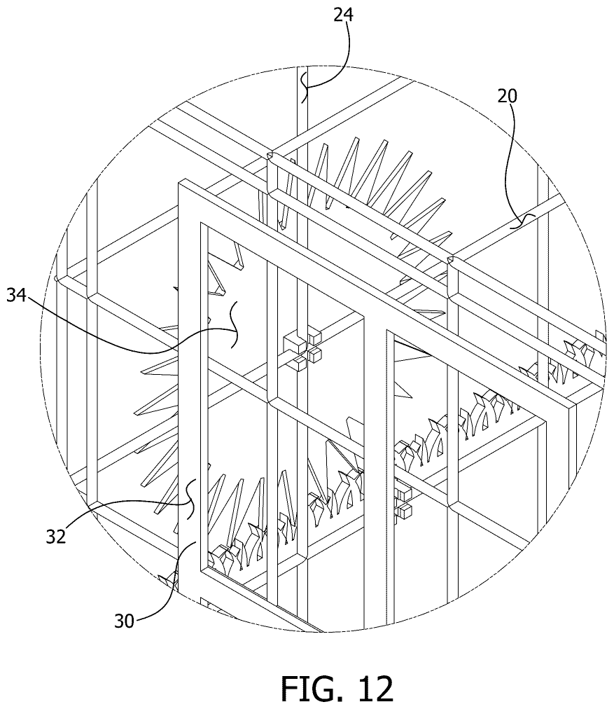

With reference now to the drawings, and in particular to FIGS. 1 through 12 thereof, a new kennel embodying the principles and concepts of an embodiment of the disclosure and generally designated by the reference numeral 10 will be described.

As best illustrated in FIGS. 1 through 12, the kennel customization device 10 generally comprises a pet crate 12 with a base 14 and a plurality of walls 16. The pet crate 12 is preferably a wire crate. More specifically, each wall of the plurality of walls 16 generally includes a plurality of first wires 18 that are spaced from each other. Each first wire of the plurality of first wires 18 has a convex outer surface 20. A plurality of second wires 22 intersect the plurality of first wires 18. For example, the plurality of second wires 22 are typically perpendicular to the plurality of first wires 18 on each wall of the plurality of walls 16. The plurality of second wires 22 are also spaced from each other. Each second wire of the plurality of second wires 22 has a convex exterior surface 24. The plurality of walls 16 may include a top wall 26, which may be parallel to the base 14. A plurality of side walls 28 extend between the top wall 26 and the base 14.

A plurality of decorations 30 are couplable to the pet crate 12. Each decoration of the plurality of decorations 30 includes a forward surface 32 that faces away from the pet crate 12 while each decoration is coupled to the pet crate 12. A rearward surface 34 faces toward the pet crate 12 while each decoration is coupled to the pet create 12. The rearward surface 34 is generally planar.

A plurality of clips 36 are coupled to the plurality of decorations 30 wherein each clip of the plurality of clips 36 is positioned on a respective decoration of the plurality of decorations 30 for coupling the respective decoration of the plurality of decorations 30 to the pet crate 12. Each clip of the plurality of clips 36 is engageable with a selectable first wire of the plurality of first wires 18 and an associated second wire of the plurality of second wires 22 on each wall of the plurality of walls 16 wherein the respective decoration of the plurality of decorations 30 is selectively positionable on each wall of the plurality of walls 16.

Each clip of the plurality of clips 36 has a hub 38 that is coupled to the rearward surface 34 of the respective decoration of the plurality of decorations 30. The hub 38 has a back side 40. The back side 40 may be planar wherein the back side 40 is positioned flush against the rearward surface 34 of the respective decoration of the plurality of decorations 30. A front side 42 of each hub 38 is parallel to the back side 40. The front side 42 may have a size that is equal to a size of the back side 40. The front side 42 may be planar wherein the front side 42 is configured to inhibit a pet within the pet crate 12 from removing the respective decoration of the plurality of decorations 30 from the pet crate 12. For example, the planar surface of the front side 42 may inhibit the pet from chewing on the front side 42 of the hub 38.

A left side 44 extends between the back side 40 and the front side 42. The left side 44 may be perpendicular to each of the back side 40 and the front side 42. A right side 46 also extends between the back side 40 and the front side 42. The right side 46 is distally positioned on each of the back side 40 and the front side 42 relative to the left side 44 wherein the right side 46 is aligned with the left side 44 along a transverse axis. The right side 46 generally has a size that is equal to a size of the left side 44.

A top side 48 extends between the back side 40 and the front side 42. A bottom side 50 also extends between the back side 40 and the front side 42. The bottom side 50 is distally positioned on each of the back side 40 and the front side 42 relative to the top side 48 wherein the bottom side 50 is aligned with the top side 48 along a longitudinal axis.

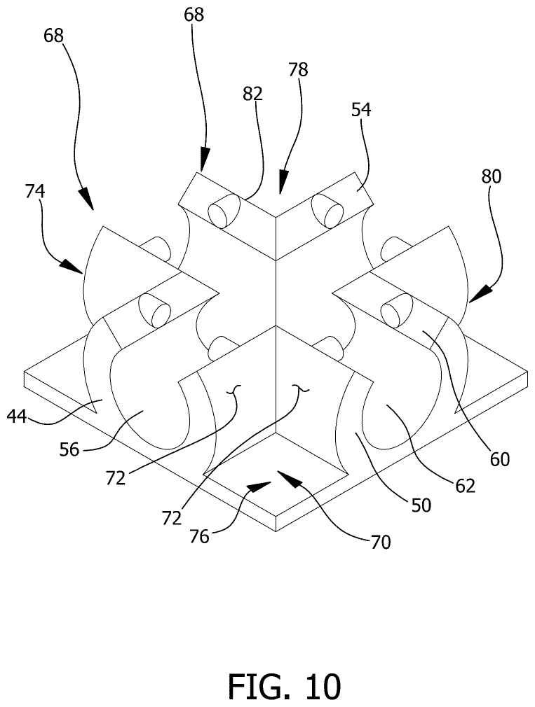

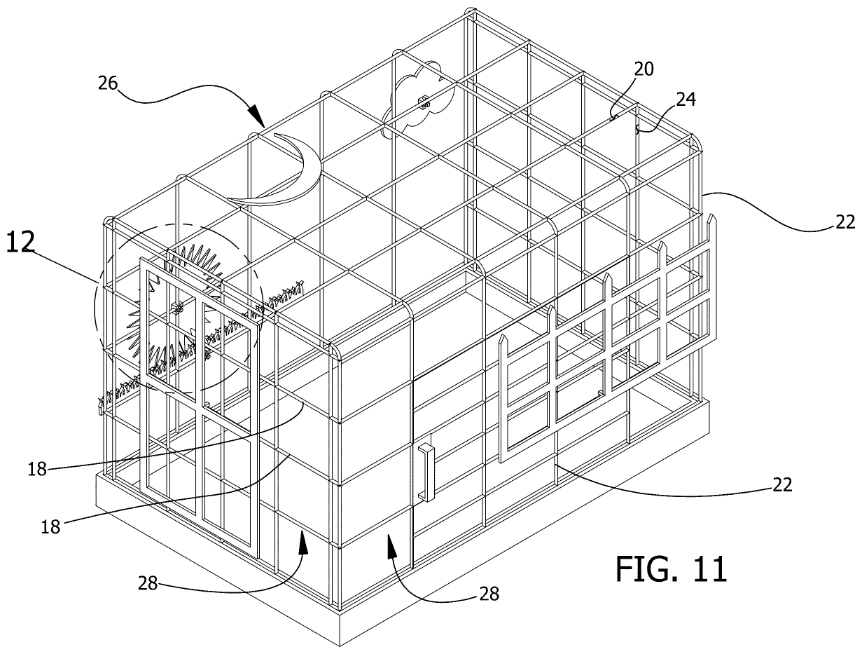

FIG. 10 depicts an example of the hub 38 wherein a plurality of cutouts 68 extend through the front side 42. Each cutout of the plurality of cutouts may have a lower surface 70 that may be parallel to the back side 40 of the hub 38. The lower surface 70 is spaced from the back side 40 of the hub 38 by a distance that is less than a distance between the front side 42 and the lower surface 70. The lower surface 70 may be rectangular, although other shapes are also contemplated. A pair of peripheral surfaces 72 are each convex between the front side 42 of the hub 38 and the lower surface 70. For example, the front side 42 of the hub 38 may define a respective upper edge 82 of each peripheral surface of the pair of peripheral surfaces 72 of each cutout of the plurality of cutouts 68.

Each cutout of the plurality of cutouts 68 may be positioned on a respective corner of the hub 38. More specifically, the plurality of cutouts 68 may include a first cutout 74 that is positioned at a junction between the left side 44 and the top side 48 of the hub. A second cutout 76 may be positioned at a junction between the left side 44 and the bottom side 50. A third cutout 78 may be positioned at a junction between the right side 46 and the top side 48. A fourth cutout 80 may be positioned at a junction between the right side 46 and the bottom side 50.

A primary channel 52 extends inwardly through the left side 44 and outwardly through the right side 46 of the hub 38. Thus, the primary channel 52 is generally aligned with, or parallel to, the transverse axis. The primary channel 52 may include a pair of outer sections 54 that are positioned on opposing surfaces of the primary channel 52. Each outer section of the pair of outer sections 54 may be planar. The outer section 54 generally extends inwardly through the front side 42 wherein a selectable first wire of the plurality of first wires 18 is positionable within the primary channel 52 through the front side 42 of the hub 38. Each outer section of the pair of outer sections 54 may have a length exceeding a diameter of the selectable first wire of the plurality of first wires 18.

A middle section 56 of the primary channel 52 extends between the pair of outer sections 54. The middle section 56 is generally concave complementary to the convex outer surface 20 of the selectable first wire of the plurality of first wires 18. The selectable first wire of plurality of first wires 18 is thus generally positionable flush against the middle section 56 when the selectable first wire is fully inserted into the primary channel 52. The middle section 56 is preferably spaced from the back side 40 of the hub 38 wherein the respective decoration of the plurality of decorations 30 is spaced from the pet crate 12 when the selectable first wire is fully inserted into the primary channel 52. Spacing the respective decoration from the pet crate 12 helps ensure the pet within the pet crate 12 cannot bite or damage the respective decoration and inhibits the pet from pushing the respective decoration off of the pet crate 12.

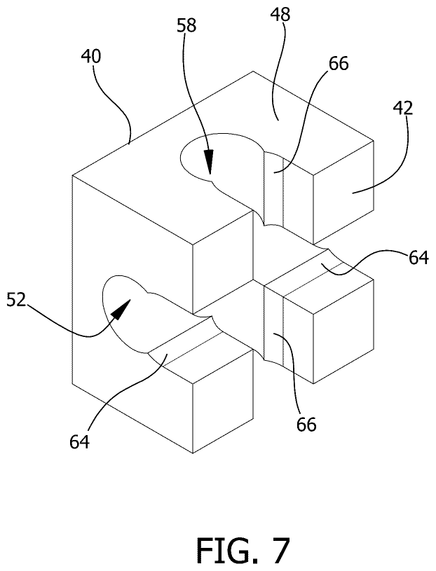

As shown in FIG. 7, each outer section of the pair of outer sections 54 may be perpendicular to the front side 42 of the hub. Alternatively, as shown in FIG. 10, each outer section of the pair of outer sections 54 of the primary channel 52 may be angled to extend downwardly from the front side 42 of the hub 38 and inwardly toward the middle section 56 such that a distance between the pair of outer sections 54 of the primary channel 52 decreases moving from the front side 42 of the hub 38 toward the middle section 56 of the primary channel 52.

A secondary channel 58 extends inwardly through the top side 48 and outwardly through the bottom side 50 of the hub 38. The secondary channel 58 is aligned with, or parallel to, the longitudinal axis. The secondary channel 58 intersects the primary channel 52 at a center point of the hub 38. Thus, the primary channel 52 and the secondary channel 58 are positionable at a junction between the selectable first wire of plurality of first wires 18 and an associated second wire of the plurality of second wires 22. When the plurality of second wires 22 are perpendicular to the plurality of first wires 18, the secondary channel 58 is perpendicular to the primary channel 52. More generally, the angle of the secondary channel 58 relative to the primary channel 52 is complementary to the angle of the plurality of second wires 22 relative to the plurality of first wires 18.

The secondary channel 58 may include a pair of outer segments 60 that are positioned on opposing surface of the secondary channel 58. Each outer segment of the pair of outer segments 60 may be planar. The outer segment 60 generally extends through the front side 42 of the hub 38 wherein the associated second wire of the plurality of second wires 22 is positionable within the secondary channel 58 through the front side 42. Each outer segment of the pair of outer segments 60 may have a length exceeding a diameter of the associated second wire of the plurality of second wires 22.

A medial segment 62 of the secondary channel 58 extends between the pair of outer segments 60. The medial segment 62 is generally concave complementary to the convex exterior surface 24 of the associated second wire of the plurality of second wires 22. Thus, the associated second wire is generally positionable flush against the medial segment 62 when the associated second wire is fully inserted into the secondary channel 58. Like the middle section 56 of the primary channel 52, the medial segment 62 is generally spaced from the back side 40 of the hub 38 wherein the respective decoration of the plurality of decorations 30 is spaced from the pet crate 12 when the associated second wire is fully inserted into the secondary channel 58.

A depth of the secondary channel 58, as measured between the front side 42 of the hub 38 and an apex of the medial segment 62, may be equal to a depth of the primary channel 52, as measured between the front side 42 of the hub 38 and an apex of the middle section 56 of the primary channel 52. In other words, a distance between the medial segment 62 of the secondary channel and the back side 40 of the hub 38 may be equal to a distance between the middle section 56 of the primary channel 52 and the back side 40 of the hub 38. In such embodiments, the respective decoration of the plurality of decorations 30 may be parallel to a selectable wall of the plurality of walls 16 on which the respective decoration is positioned.

As shown in FIG. 7, each outer segment of the pair of outer segments 60 may be perpendicular to the front side 42 of the hub 38. Alternatively, as shown in FIG. 10, each outer segment of the pair of outer segments 60 of the secondary channel 58 may be angled to extend downwardly from the front side 42 of the hub 38 and inwardly toward the medial segment 62 such that a distance between the pair of outer segments 60 of the secondary channel decreases moving from the front side 42 of the hub 38 toward the medial segment 62 of the secondary channel 58.

A set of primary stops 64 may be positioned to extend from the pair of outer sections 54 of the primary channel 52. A distance between opposing primary stops of the set of primary stops 64 is less than a distance between the pair of outer sections 54 of the primary channel 52. By restricting the width of the primary channel 52, the set of primary stops 64 inhibit the respective decoration of the plurality of decorations 30 from falling off of the pet crate 12 while the selectable first wire of the plurality of first wires 18 is positioned between the set of primary stops 64 and the middle section 56 of the primary channel 52. The set of primary stops 64 may be positioned proximate to the front side 42 of the hub 38. In other words, a distance between the back side 40 of the hub 38 and each primary stop of the set of primary stops 64 may exceed a distance between the front side 42 and each primary stop of the set of primary stops 64.

A set of secondary stops 66 may be positioned to extend from the pair of outer segments 60 of the secondary channel 58. A distance between opposing secondary stops of the set of secondary stops 66 is less than a distance between the pair of outer segments 60 of the secondary channel 58. Thus, the set of secondary stops 66 inhibit the respective decoration of the plurality of decorations 30 from falling off of the pet create while the associated second wire of the plurality of second wires 22 is positioned between the set of secondary stops 66 and the medial segment 62 of the secondary channel 58. The set of secondary stops 66 may be positioned proximate to the front side 42 of the hub 38. Accordingly, a distance between the back side 40 of the hub 38 and each secondary stop of the set of secondary stops 66 may exceed a distance between the front side 42 and each secondary stop of the set of secondary stops 66.

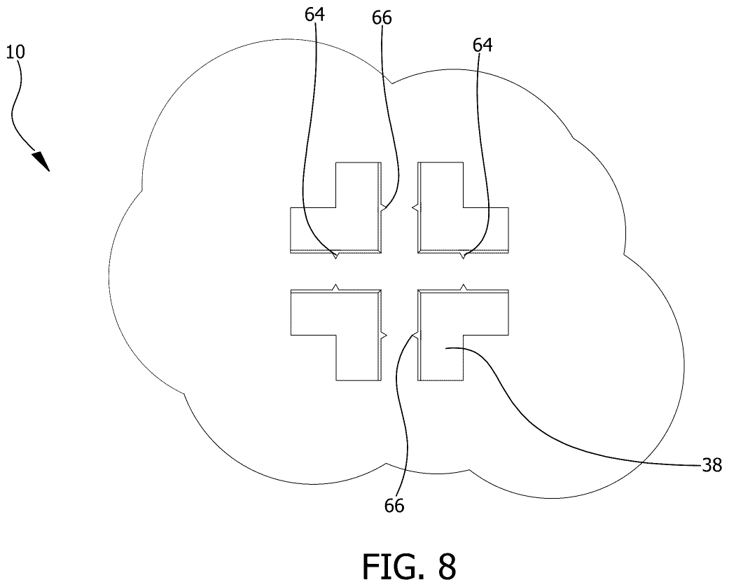

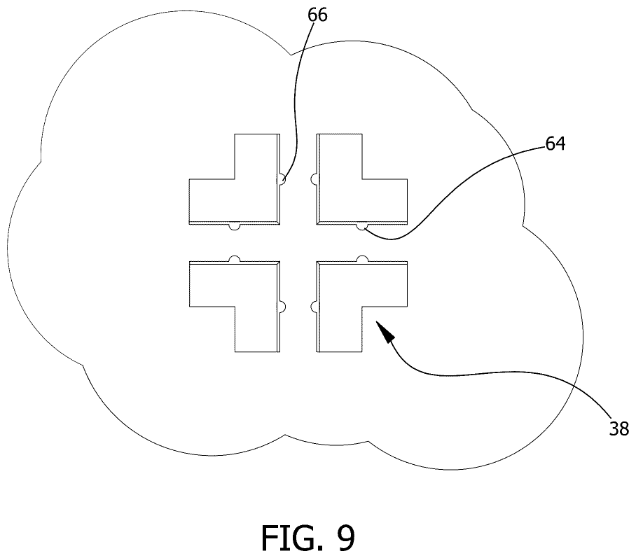

Each primary stop of the set of primary stops 64 may be a triangular prism. Additionally, each secondary stop of the set of secondary stops 66 may be a triangular prism. FIGS. 7 and 8 provide examples of such embodiments. In other embodiments, such as that shown in FIG. 9, each primary stop of the set of primary stops 64 is spherical and each secondary stop of the set of secondary stops 66 is spherical. Alternative shapes for the set of primary stops 64 and the set of secondary stops 66 are also contemplated, including, but not limited to, cylinders as shown in FIG. 10 and rectangular prisms.

In use, the plurality of decorations 30 can be coupled to the plurality of first wires 18 and the plurality of second wires 22 via the plurality of clips 36. Each clip of the plurality of clips 36 is attached to a respective decoration of the plurality of decorations 30 for removably coupling the respective decoration to the selectable wall of the plurality of walls 16 of the pet crate 12. Each clip of the plurality of clips 36 can simply be pushed onto the selectable first wire of the plurality of first wires 18 and the associated second wire of the plurality of second wires 22 until the selectable first wire is positioned within the primary channel 52 and the associated second wire is positioned within the secondary channel 58.

The set of primary stops 64 and the set of secondary stops 66 keep the plurality of decorations 30 from falling off of the pet crate 12 unless the plurality of decorations 30 are pulled away from the plurality of walls 16 of the pet crate 12 by the user. The intersection between the primary channel 52 and the secondary channel 58 facilitates coupling each clip to the selectable wall of the plurality of walls 16 at a junction between the plurality of first wires 18 and the plurality of second wires 22. Positioning each clip at the junction between the plurality of first wires 18 and the plurality of second wires 22 also keeps the plurality of decorations 30 in place on the pet crate 12, such that the respective decoration does not slide along the selectable wall after being coupled to the pet create 12. The plurality of decorations 30 may be placed at any junction between the plurality of first wires 18 and the plurality of second wires 22 on any wall of the plurality of walls 16. The plurality of decorations 30 may have any shape or color, providing the user with versatile options for customizing the aesthetic features of the pet crate 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A kennel decoration system comprising:
a pet crate having a base and a plurality of walls, each wall of the plurality of walls including:
a plurality of first wires; and
a plurality of second wires intersecting the plurality of first wires;
a plurality of decorations being couplable to the pet crate; and
a plurality of clips being coupled to the plurality of decorations for coupling the plurality of decorations to the pet crate, each clip of the plurality of clips including:
a hub including:
a back side;
a front side;
a left side extending between the back side and the front side;
a right side extending between the back side and the front side;
a top side extending between the back side and the front side; and
a bottom side extending between the back side and the front side;
a plurality of cutouts extending through the front side, each cutout of the plurality of cutouts having:
a lower surface being parallel to the back side of the hub, the lower surface being spaced from the back side of the hub by a distance being less than a distance between the front side and the lower surface; and
a pair of peripheral surfaces being convex between the front side of the hub and the lower surface wherein the front side defines an upper edge of the peripheral surface of each cutout of the plurality of cutouts;
a primary channel extending inwardly through the left side and outwardly through the right side, the primary channel including:
a pair of outer sections being positioned on opposing surfaces of the primary channel; and
a middle section extending between the pair of outer sections, the middle section being concave; and
a secondary channel extending inwardly through the top side and outwardly through the bottom side of the hub, opposed surfaces of the secondary channel including:
a pair of outer segments being positioned on opposing surfaces of the secondary channel; and
a medial segment extending between the pair of outer segments, the medial segment being concave.

2. The kennel decoration system of claim 1, wherein the secondary channel intersects the primary channel at a center point of the hub wherein the primary channel and the secondary channel are positionable at a junction between a selectable first wire of plurality of first wires and an associated second wire of the plurality of second wires.

3. The kennel decoration system of claim 1, wherein the front side of the hub of each clip of the plurality of clips is planar wherein the front side is configured to inhibit a pet within the pet crate from removing the respective decoration of the plurality of decorations from the pet crate.

4. The kennel decoration system of claim 1, wherein the right side of the hub is distally positioned on each of the back side and the front side relative to the left side wherein the right side is aligned with the left side along a transverse axis.

5. The kennel decoration system of claim 4, wherein the primary channel is aligned with the transverse axis.

6. The kennel decoration system of claim 4, wherein the bottom side of the hub is distally positioned on each of the back side and the front side relative to the top side wherein the bottom side is aligned with the top side along a longitudinal axis.

7. The kennel decoration system of claim 6, wherein the secondary channel is aligned with the longitudinal axis.

8. The kennel decoration system of claim 1, further comprising a set of primary stops being positioned to extend from each outer section of the pair of outer sections of the primary channel wherein a distance between opposing primary stops of the set of primary stops is less than a distance between the pair of outer sections whereby the set of primary stops inhibit the respective decoration of the plurality of decorations from falling off of the pet crate while the selectable first wire of the plurality of first wires is positioned between the set of primary stops and the middle section of the primary channel.

9. The kennel decoration system of claim 8, wherein the set of primary stops are positioned proximate to the front side of the hub wherein a distance between the back side of the hub and each primary stop of the set of primary stops exceeds a distance between the front side of the hub and each primary stop of the set of primary stops.

10. The kennel decoration system of claim 8, further comprising a set of secondary stops being positioned to extend from each outer segment of the pair of outer segments of the secondary channel wherein a distance between opposing secondary stops of the set of secondary stops is less than the distance between the pair of outer segments whereby the set of secondary stops inhibit the respective decoration of the plurality of decorations from falling off of the pet create while the associated second wire of the plurality of second wires is positioned between the set of secondary stops and the medial segment of the secondary channel.

11. The kennel decoration system of claim 10, wherein the set of secondary stops is positioned proximate to the front side of the hub wherein a distance between the back side of the hub and each secondary stop of the set of secondary stops exceeds a distance between the front side and each secondary stop of the set of secondary stops.

12. The kennel decoration system of claim 1, wherein each outer section of the pair of outer sections of the primary channel is perpendicular to the front side of the hub.

13. The kennel decoration system of claim 12, wherein the middle section of the primary channel is spaced from the back side of the hub wherein the respective decoration of the plurality of decorations is spaced from the pet crate when the selectable first wire is fully inserted into the primary channel.

14. The kennel decoration system of claim 1, wherein each outer segment of the pair of outer segments of the secondary channel extends through the front side of the hub wherein the associated second wire of the plurality of second wires is positionable within the secondary channel through the front side.

15. The kennel decoration system of claim 14, wherein the medial segment of each opposed surface of the secondary channel is spaced from the back side of the hub wherein the respective decoration of the plurality of decorations is spaced from the pet crate when the associated second wire is fully inserted into the secondary channel.

16. A kennel decoration system comprising:
a pet crate having a base and a plurality of walls, the pet crate being a wire crate wherein each wall of the plurality of walls includes:
a plurality of first wires being spaced from each other, each first wire of the plurality of first wires having a convex outer surface; and
a plurality of second wires intersecting the plurality of first wires, the plurality of second wires being perpendicular to the plurality of first wires on each wall of the plurality of walls, the plurality of second wires being spaced from each other, each second wire of the plurality of second wires having a convex exterior surface;
the plurality of walls including:
a top wall being parallel to the base; and
a plurality of side walls extending between the top wall and the base;
a plurality of decorations being couplable to the pet crate, each decoration of the plurality of decorations including:
a forward surface facing away from the pet crate; and
a rearward surface facing toward the pet crate, the rearward surface being planar; and
a plurality of clips being coupled to the plurality of decorations wherein each clip of the plurality of clips is positioned on a respective decoration of the plurality of decorations for coupling the respective decoration of the plurality of decorations to the pet crate, each clip of the plurality of clips being engageable with the plurality of first wires and the plurality of second wires on each wall of the plurality of walls wherein the respective decoration of the plurality of decorations is selectively positionable on each wall of the plurality of walls, each clip of the plurality of clips including:
a hub being coupled to the rearward surface of the respective decoration of the plurality of decorations, the hub including:
a back side being planar wherein the back side is positioned flush against the rearward surface of the respective decoration of the plurality of decorations;
a front side being parallel to the back side;
a left side extending between the back side and the front side, the left side being perpendicular to each of the back side and the front side;
a right side extending between the back side and the front side, the right side being distally positioned on each of the back side and the front side relative to the left side wherein the right side is aligned with the left side along a transverse axis, the right side having a size being equal to a size of the left side;
a top side extending between the back side and the front side; and
a bottom side extending between the back side and the front side, the bottom side being distally positioned on each of the back side and the front side relative to the top side wherein the bottom side is aligned with the top side along a longitudinal axis;
a plurality of cutouts extending through the front side, each cutout of the plurality of cutouts having:
a lower surface being parallel to the back side of the hub, the lower surface being spaced from the back side of the hub by a distance being less than a distance between the front side and the lower surface, the lower surface being rectangular; and
a pair of peripheral surfaces being convex between the front side of the hub and the lower surface wherein the front side defines an upper edge of the peripheral surface of each cutout of the plurality of cutouts;
a primary channel extending inwardly through the left side and outwardly through the right side of the hub wherein the primary channel is aligned with the transverse axis, the primary channel including:
a pair of outer sections being positioned on opposing surfaces of the primary channel, each outer section of the pair of outer sections being planar, the pair of outer sections extending inwardly through the front side wherein a selectable first wire of the plurality of first wires is positionable within the primary channel through the front side; and
a middle section extending between the pair of outer sections, the middle section being concave complementary to the convex outer surface of the selectable first wire of the plurality of first wires wherein the selectable first wire of plurality of first wires is positionable flush against the middle section when the selectable first wire is fully inserted into the primary channel, the middle section being spaced from the back side of the hub wherein the respective decoration of the plurality of decorations is spaced from the pet crate when the selectable first wire is fully inserted into the primary channel;
a secondary channel extending inwardly through the top side and outwardly through the bottom side of the hub wherein the secondary channel is aligned with the longitudinal axis, the secondary channel intersecting the primary channel at a center point of the hub wherein the primary channel and the secondary channel are positionable at a junction between the selectable first wire of plurality of first wires and an associated second wire of the plurality of second wires, the secondary channel including:
a pair of outer segments being positioned on opposing surface of the secondary channel, each outer segment of the pair of outer segments being planar, the pair of outer segments extending through the front side wherein the associated second wire of the plurality of second wires is positionable within the secondary channel through the front side; and
a medial segment extending between the pair of outer segments, the medial segment being concave complementary to the convex exterior surface of the associated second wire of the plurality of second wires wherein the associated second wire is positionable flush against the medial segment when the associated second wire is fully inserted into the secondary channel, the medial segment being spaced from the back side of the hub wherein the respective decoration of the plurality of decorations is spaced from the pet crate when the associated second wire is fully inserted into the secondary channel;
a set of primary stops being positioned to extend from the pair of outer sections of the primary channel wherein a distance between opposing primary stops of the set of primary stops is less than a distance between the pair of outer sections whereby the set of primary stops inhibit the respective decoration of the plurality of decorations from falling off of the pet crate while the selectable first wire of the plurality of first wires is positioned between the set of primary stops and the middle section of the primary channel, the set of primary stops being positioned proximate to the front side of the hub wherein a distance between the back side of the hub and each primary stop of the set of primary stops exceeds a distance between the front side and each primary stop of the set of primary stops; and
a set of secondary stops being positioned to extend from the pair of outer segments of the secondary channel wherein a distance between opposing secondary stops of the set of secondary stops is less than the distance between the pair of outer segments whereby the set of secondary stops inhibit the respective decoration of the plurality of decorations from falling off of the pet create while the associated second wire of the plurality of second wires is positioned between the set of secondary stops and the medial segment of the secondary channel, the set of secondary stops being positioned proximate to the front side of the hub wherein a distance between the back side of the hub and each secondary stop of the set of secondary stops exceeds a distance between the front side and each secondary stop of the set of secondary stops.

17. The kennel decoration system of claim 16, wherein each primary stop of the set of primary stops is triangular and wherein each secondary stop of the set of secondary stops is triangular.

18. The kennel decoration system of claim 16, wherein each primary stop of the set of primary stops is cylindrical and wherein each secondary stop of the set of secondary stops is cylindrical.

19. The kennel decoration system of claim 16, wherein each outer section of the pair of outer sections of the primary channel is angled to extend downwardly from the front side of the hub and inwardly toward the middle section such that a distance between the pair of outer sections of the primary channel decreases moving from the front side of the hub toward the middle section of the primary channel, each outer segment of the pair of outer segments of the secondary channel being angled to extend downwardly from the front side of the hub and inwardly toward the medial segment such that a distance between the pair of outer segments of the secondary channel decreases moving from the front side of the hub toward the medial segment of the secondary channel.
